(19) United States
(12) Patent Application Publication
(10) Pub. No.: US 2007/0229640 A1
(43) Pub. Date: Oct. 4, 2007

(54) Using paper type sensor to prohibit feeding of unsupported paper types

(76) Inventors: Christa A. Ferguson, Round Rock, TX (US); Charles G. Morton III, Leander, TX (US)

Correspondence Address: HAMILTON & TERRILE, LLP, P.O. BOX 203518, AUSTIN, TX, 78720, US

(21) Appl. No.: 11/392,388

(22) Filed: Mar. 29, 2006

(51) Int. Cl. B41J 2/01

(52) U.S. Cl. 347/104

(57) ABSTRACT

A printer which includes a printer housing, a printing mechanism, a media supply, a paper handling mechanism, a media sensor and a media supply module. The paper handling mechanism moves media from the media supply through the print mechanism so that the print mechanism is upstream of the media supply. The media sensor generates media sense information based upon a type of media contained in the media supply. The media supply module uses the media sense information to prohibit feeding of unsupported media types from the media supply.

### BACKGROUND OF THE INVENTION

1. Field of the Invention

The present invention relates to the field of printers and more particularly to a system for using paper type information to prohibit feeding of unsupported paper types within a printer.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. One example of an information handing system is a printer.

Known printers often have different types of jobs that they perform well. For example, laser printers provide inexpensive high volume print jobs of bonded paper while ink jet printers provide photographic quality prints (e.g., color prints having at least 300 dots per inch resolution), often using specialized ink jet photo paper.

With the increasing availability of color laser printers users often print photographs via the color laser printer. One issue relating to printing photographs on laser printer relates to the type of paper used to print the photograph. It is possible to select an incorrect photo quality paper which could damage interior components of the laser printer. Inkjet photo quality paper is generally not supported on color laser printers. Though this is stated in the user's guide, users can still make this error.

Known laser printers do not include a media type sensor to detect correct versus incorrect print media. Additionally, known laser printers do not provide a user with a message regarding the incorrect media type, or stopping or pausing a print job based on the presence of incorrect media.

Known inkjet media type sensors report the media type, but laser jet photo paper is not prevented from printing within the inkjet printer as the printer won't get damaged if it prints on laser photo paper. The inkjet print quality will suffer since laser photo paper does not provide an appropriate surface for ink. Additionally, known media sensors report both inkjet photo paper and laser photo paper as Photo media.

### SUMMARY OF THE INVENTION

In accordance with the present invention, a system for using paper type information to prohibit feeding of unsupported paper types within a printer is set forth. More specifically, the system is included within a laser printer having an integrated media type sensor. The media type sensor detects what kind of paper is being used for the print job before the print job starts printing. If the media type sensor detects an unsupported media type (such as ink jet photo paper), the job is paused and the user is prompted to replace the media with supported media. As long as the media type sensor detects media that will damage the printer, the job will not print. The media sensor detects differences in the surface of the print media. Firmware within the printer prohibits inkjet photo paper from feeding and thus from printing based on these differences, but allows laser photo paper to feed and print. The media sensor detects the media type based upon the reflectivity of the media surface.

In another embodiment, an inkjet printer can include the integrated media type sensor which when detecting that an unsupported media type is present within the media source, pauses the print job and prompts the user to replace the media with a supported media.

In another embodiment, the invention relates to a printer which includes a printer housing, a printing mechanism, a media supply, a paper handling mechanism, a media sensor and a media supply module. The paper handling mechanism moves media from the media supply through the print mechanism so that the print mechanism is upstream of the media supply. The media sensor generates media sense information based upon a type of media contained in the media supply. The media supply module uses the media sense information to prohibit feeding of unsupported media types from the media supply.

In another embodiment, the invention relates to an information handling system which includes a housing, a printing mechanism, a media supply, a paper handling mechanism, a media sensor and a media supply module. The paper handling mechanism moves media from the media supply through the print mechanism so that the print mechanism is upstream of the media supply. The media sensor generates media sense information based upon a type of media contained in the media supply. The media supply module uses the media sense information to prohibit feeding of unsupported media types from the media supply.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer having the system for using paper type information to prohibit feeding of unsupported paper types is used.

FIG. 2 shows a block diagram of a laser printer having an integrated media type sensor.

FIG. 3 shows the operation of a system for using paper type sensor to prohibit feeding of unsupported paper types within a printer.

FIG. 4 shows a screen presentation of the results of a media sense of laser photo paper.

FIG. 5 shows a screen presentation of the results of a media sense of inkjet photo paper.

### DETAILED DESCRIPTION

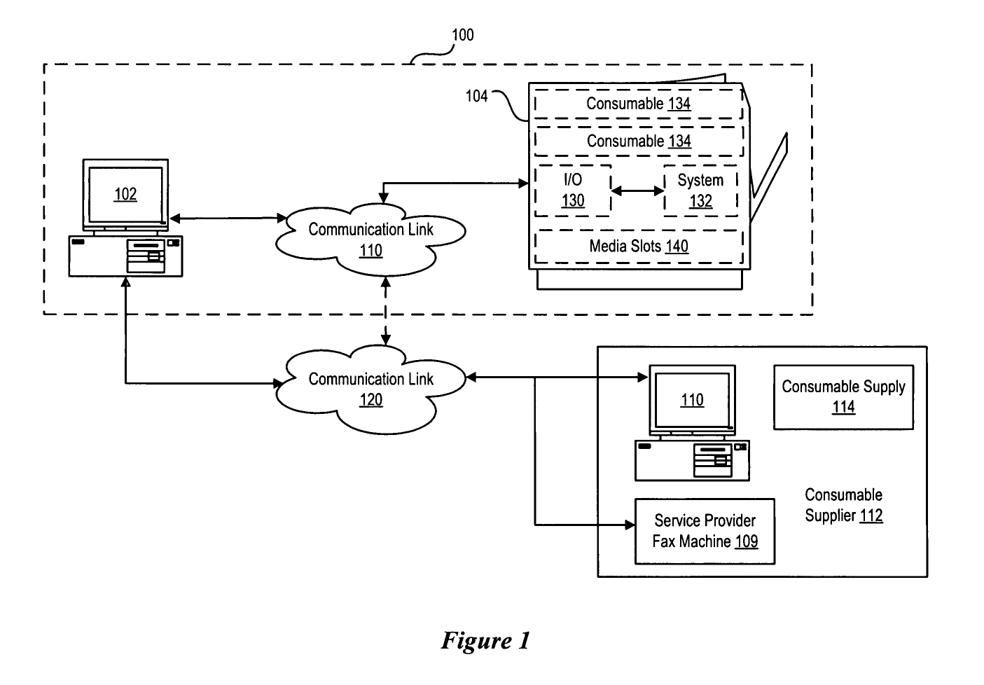

Referring to FIG. 1, a block diagram of an environment in which a printer having the system for using paper type information to prohibit feeding of unsupported paper types is used is shown. The environment includes a computer system 102 and a printer 104, coupled via a communication link 110. The communication link 110 might be a printer cable, a telephone cable, a network connection or any other link which information is communicated with the printer 104. In one embodiment, the printer 104 is included within a multifunction device such as a combination printer fax machine. Other functions may also be included within the multifunction device such as a scan function and a copy function. Also, in one embodiment, the environment does not include a computer system 102.

The printer 104 is coupled to a second communication link 120. Thus, communication may occur between the printer 104 and anything coupled to the second communication link 120 such as a services provider fax machine 109. Additionally, the computer system 102 is also connected to another computer system (e.g., a services provider computer system) 110 via a second communication link 120. The second communication link 120 may be a telephone system or some other type of network, such as the Internet. In one embodiment, the fax machine 109 and the computer system 110 are owned and operated by a fax machine service provider 112. In this example, the printer service provider 112 provides service for the hybrid printer 104.

The printer 104 includes an input output (I/O) port 130, a control system 132 and at least two types of consumables 134. The I/O port 130 facilitates communications between the hybrid printer 104 and other devices connected to the communications link 110. The control system 132 provides the hybrid printer 104 with certain control functionality. The control system 132 includes a processor and memory coupled to the processor. The hybrid printer 104 may also include one or more media slots 140.

The consumables 134 represent any component in the hybrid printer 104 that is subject to depletion through use of the printer 104. For example, the consumable 134 may be a toner cartridge or an inkjet cartridge, etc. The printer service provider maintains a supply 114 of replacement consumables 134.

In operation, the computer system 102 generates a document in an electronic form and transmits the document (in the form of a print job) to the printer 104. The printer 104 receives the job via the I/O port 130 and prints the document. Additionally, when the printer 104 is part of a multifunction device, the printer 104 may receive and print information from the communication link 120 or from a scanned image when operating as a copier. Additionally, the printer 104 may receive and print information from any of its media slots 140.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

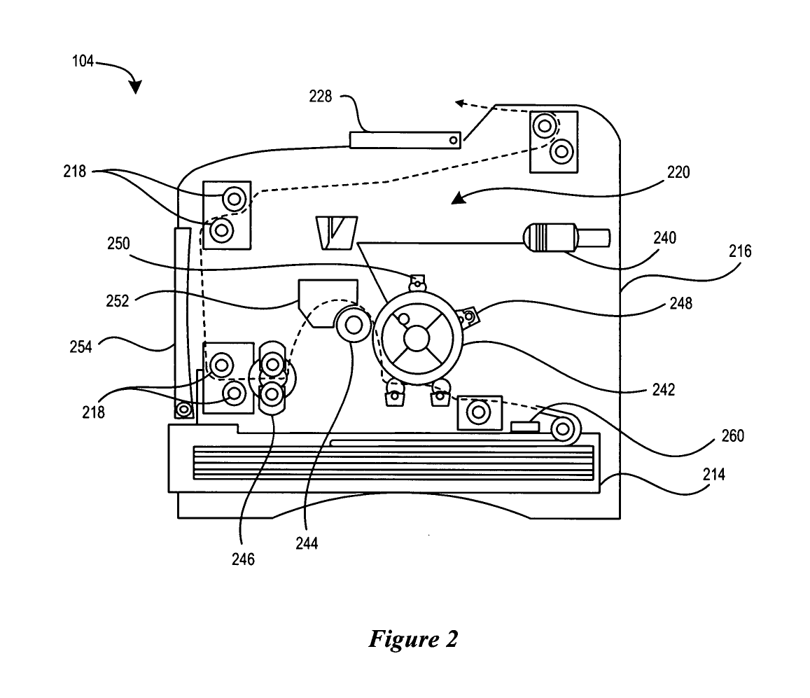

Referring to FIG. 2, printer 104 includes a media source which provides media to a printing mechanism. The media source includes for example a paper tray 214 contained within a printer housing 216. The printer 104 also includes a paper handling mechanism for moving paper along a paper path through the printer housing. In one embodiment, the paper handling mechanism includes a plurality of rollers 218.

The printer 104 includes the printing mechanism 220 which includes, for example, a laser scanning unit 240, a photoreceptor drum assembly 242, a developer roller 244, a fuser 246, a discharge lamp 248, a corona wire 250 and a toner hopper 252. The toner hopper 252 is a printer consumable 134. The printer 104 includes a laser jet consumable access door 254.

The laser printer 104 includes an integrated media type sensor 260. The integrated media type sensor is included within the paper tray 214. The media sensor 260 detects differences in the surface of the print media. Firmware within the control system 132 of the printer 104 prohibits printing inkjet photo paper based on these differences, but allows laser photo paper. The media sensor 260 detects the media type based upon the reflectivity of the media surface. The media sensor 260 is positioned so that the paper type is read prior to the paper entering the paper handling mechanism so that if an unsupported paper type is detected, the paper may be easily removed before the paper enters the paper handling mechanism.

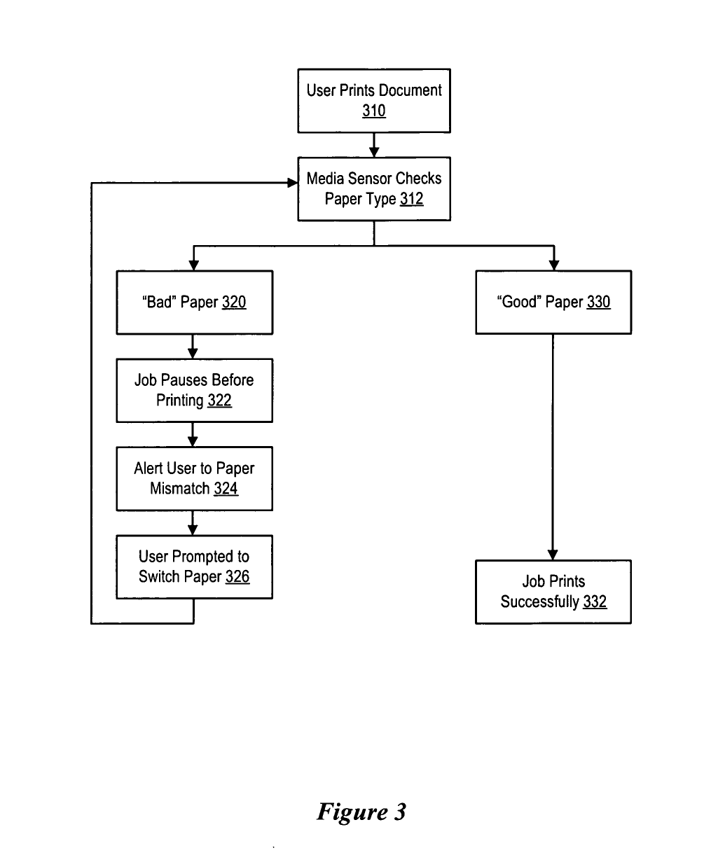

FIG. 3 shows the operation of a system for using paper type sensor to prohibit feeding of unsupported paper types within a printer. More specifically, when a user attempts to print a document at step 310, the media type sensor 260 detects what kind of print media (e.g., paper) is being used for the print job before the print job starts printing at step 312. If the media type sensor 262 detects an unsupported media type (such as ink jet photo paper) (i.e., bad paper) at step 320, the job is paused before printing at step 322. Next the user is alerted to the paper mismatch at step 324 and the user is prompted to replace the media with supported media at step 326. As long as the media type sensor 260 detects media that will damage the printer, the job will not print.

If the media type sensor 260 detects a supported media type (i.e., good paper), at step 330, then the print job prints successfully at step 332.

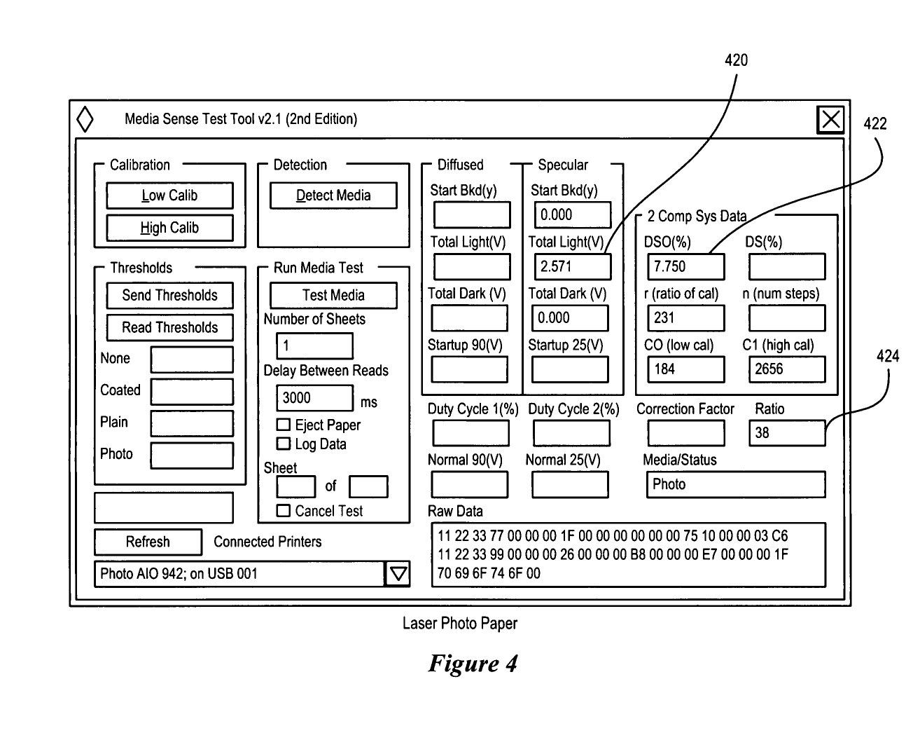

FIG. 4 shows a screen presentation of the results of a media sense of laser photo paper. This screen presentation may be presented, for example, via computer system 102. More specifically, the media sensor 260 generates raw data 510 based upon a type of media sensed. The media sense raw data may be separated into media description values. These media description values include a brightness value and a reflectivity of paper value as indicated in one embodiment by a total light value 520, a (DSO %) value 522, and a ratio value 524. For a sample laser photo paper sense the total light value 520 equals 2.571, the DSO % value equals 7.750 and the ration value equals 38.

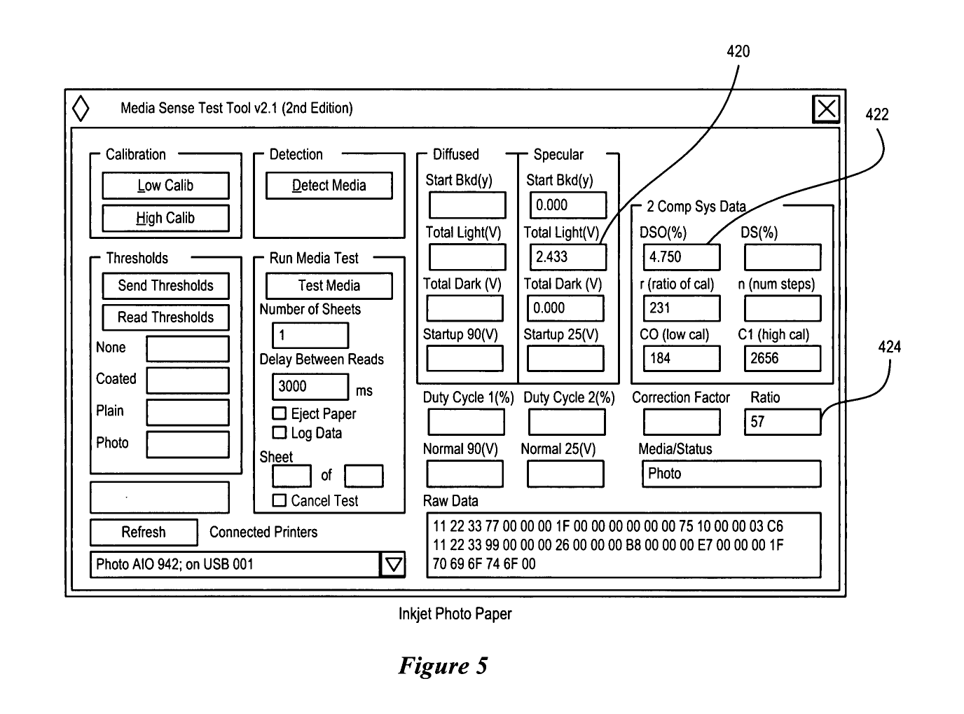

FIG. 5 shows a screen presentation of the results of a media sense of inkjet photo paper. This screen presentation may be presented, for example, via computer system 102. For a sample inkjet photo paper sense the total light value 520 equals 2.433, the DSO % value equals 4.750 and the ration value equals 57.

The system for using paper type information to prohibit feeding of unsupported paper types uses the media description values to differentiate between unsupported media and supported media.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that the printing mechanism can include color laser jet functionality. In such a system, the control system 132 can track each of the color laser jet printer consumables and selectively use the corresponding ink jet when a particular color laser jet printer consumable is depleted.

Also for example, it will be appreciated that the consumable provider and the printer supplier could be the same entities or different entities.

Consequently, the invention is intended to be limited only by the spirit and scope of the appended claims, giving full cognizance to equivalents in all respects.

What is claimed is:

1. A printer comprising:
a printer housing;
a printing mechanism;
a media supply;
a paper handling mechanism, the paper handling mechanism moving media from the media supply through the print mechanism so that the print mechanism is upstream of the media supply;
a media sensor, the media sensor generating media sense information based upon a type of media contained in the media supply; and,
a media supply module, the media supply module using the media sense information to prohibit feeding of unsupported media types from the media supply.

2. The printer of claim 1 wherein:
the printing mechanism includes a laser printing mechanism.

3. The printer of claim 2 wherein:
the unsupported media types include inkjet photo paper.

4. The printer of claim 1 wherein:
the printing mechanism includes an inkjet printing mechanism.

5. The printer of claim 4 wherein:
the unsupported media types include laser photo paper.

6. The printer of claim 1 further comprising:
a control system, the control system including the media supply module.

7. The printer of claim 1 wherein:
the media sense information includes a plurality of media description values, at least one of media description values being different for supported media and unsupported media.

8. An information handling system comprising:
a housing;
a printing mechanism;
a media supply;
a paper handling mechanism, the paper handling mechanism moving media from the media supply through the print mechanism so that the print mechanism is upstream of the media supply;
a media sensor, the media sensor generating media sense information based upon a type of media contained in the media supply; and,
a media supply module, the media supply module using the media sense information to prohibit feeding of unsupported media types from the media supply.

9. The information handling system of claim 8 wherein:
the printing mechanism includes a laser printing mechanism.

10. The information handling system of claim 9 wherein:
the unsupported media types include inkjet photo paper.

11. The information handling system of claim 8 wherein:
the printing mechanism includes an inkjet printing mechanism.

12. The information handling system of claim 11 wherein:
the unsupported media types include laser photo paper.

13. The information handling system of claim 8 further comprising:
a control system, the control system including the media supply module.

14. The information handling system of claim 8 wherein:
the media sense information includes a plurality of media description values, at least one of media description values being different for supported media and unsupported media.
